(19) United States
(12) Patent Application Publication
(10) Pub. No.: US 2024/0233228 A1
(43) Pub. Date: Jul. 11, 2024

(54) Medical Image Rendering Technique

(71) Applicant: Siemens Healthineers AG, Forchheim (DE)

(72) Inventors: Kaloian Petkov, Lawrenceville, NJ (US); Rishabh Shah, Wentworth Point (AU)

(21) Appl. No.: 18/538,050

(22) Filed: Dec. 13, 2023

(30) Foreign Application Priority Data
Jan. 11, 2023 (EP) 23151086.8

(51) Int. Cl. G06T 13/20; G06T 7/00

(52) U.S. Cl. CPC G06T 13/20; G06T 7/0012; G06T 2207/20084

(57) ABSTRACT

Animations of medical images are rendered. At least one input is received. Each input is a medical image dataset. A set of keyframes associated with the received input is selected. A keyframe is predetermined values of a set of rendering parameters. Intermediary frames are generated in a temporal sequence between two consecutive, according to a temporal ordering, keyframes. Generating the intermediary frames is based on optimizing a perceptual metric associated with the selected set of keyframes and the generated intermediary frames. The perceptual metric is optimized as a function of values of the set of rendering parameters associated with each of the intermediary frames. An animation using the generated intermediary frames and the selected set of keyframes is rendered.

### RELATED APPLICATION

This application claims the benefit of EP 23151086.8, filed on Jan. 11, 2023, which is hereby incorporated by reference in its entirety.

### FIELD

The present disclosure relates to a rendering technique for rendering animations of medical images.

### BACKGROUND

Volume rendering spans a wide variety of algorithms, which support different visual effects and may pose different computational challenges. Conventional volume visualization methods based on ray casting, which are still used in many current advanced visualization medical products, simulate only the emission and absorption of radiant energy along the primary viewing rays through the volume data. The emitted radiant energy at each point is absorbed according to the Beer-Lambert law along the ray to the observer location with absorption coefficients derived from the patient data. Renderers conventionally compute shading using only the standard local shading models at each point along the ray (e.g., the Blinn-Phong model), based on the local volume gradients (also denoted as local illumination). While fast, these methods do not simulate the complex light scattering and extinction associated with photorealism (also denoted as global illumination).

Monte Carlo path tracing is a global illumination algorithm, which solves the rendering equation using Monte Carlo integration. It can produce highly realistic images, including for medical visualization. At the same time, the computational requirements are very high since hundreds to thousands of discrete light paths need to be simulated at each pixel. As more and more paths are simulated, the solution converges on an accurate estimation of the irradiance at each point for incoming light from all directions. The renderer conventionally employs a hybrid of volumetric scattering and surface-like scattering, modeled by phase functions and bidirectional reflectance distribution functions (BRDFs), respectively, based on properties derived from the anatomical data. Producing a single image using a global illumination algorithm, in particular Monta Carlo path tracing, may take on the order of minutes and is currently not suitable for real-time rendering at full quality. A variety of algorithms address the performance challenges, including irradiance caching, which, however, requires a long pre-computation on lighting changes before real-time rendering is possible, and AI-based denoising and light path generation.

Differentiable rendering (DR) models the explicit relationship between rendering parameters and resulting images in conventional image synthesis. DR obtains image-space derivatives with respect to the rendering parameters, which can be used in a variety of gradient-based optimization methods to solve inverse rendering problems or to compute the loss for training machine learning (ML) models directly in the space of rendered images. While many existing differentiable renderers, such as OpenDR, are limited to simple surface rendering and local shading, there are examples for photorealistic surface and participating media rendering. More recently, Weiss and Westermann introduced a differentiable direct volume rendering system based on automatic differentiation that is capable of computing image-space derivatives with respect to rendering parameters, the transfer function, and the volume densities.

Keyframing is a common animation technique in computer graphics, where a system interpolates a sparse set of keyframes along a timeline, and each frame contains the rendering parameters, scene descriptions, actions, and any further information needed to render an image. While keyframing allows for very tight control over the animation (e.g., as opposed to physically-based animation systems), the creation and timing of the keyframes can be a very tedious process for an, in particular human, animator and require significant expertise to produce well-paced videos.

### SUMMARY AND DETAILED DESCRIPTION

It is therefore an object to provide an efficient solution and/or an efficient technique for, in particular automatically and/or promptly, creating a smooth, consistent and/or easily comprehensible animation from a (e.g., sparse) set of keyframes comprising medical images.

This object is solved by a, in particular computer-implemented, method for rendering animations of medical images, by a computing device for rendering animations of medical images, by a system comprising the computing device, and by a computer program (and/or by a non-transitory computer-readable medium). Advantageous aspects, features and embodiments are described in the dependent claims and in the following description.

In the following, the solution and/or technique is described with respect to the claimed, in particular computer-implemented, method for rendering animations of medical images as well as with respect to the claimed computing device and system comprising the computing device. Features, advantages or alternative embodiments herein can be assigned to the other claimed objects (e.g., the computer program or a computer program product), and vice versa. In other words, claims for the computing device and the system for rendering animations of medical images can be improved with features described or claimed in the context of the method, and vice versa. In this case, the functional features of the method are embodied by configured structure of the computing device and the system and vice versa, respectively.

As to a method aspect, a, in particular computer-implemented, method for rendering animations of medical images is provided. The method includes an act of receiving at least one input. Each of the at least one input includes a medical image dataset. The method further includes an act of selecting a set of keyframes associated with the received at least one input. A keyframe includes a predetermined value for each (and/or at least one, and/or one or more selected) rendering parameter within a set of rendering parameters. The method further includes an act of generating intermediary frames in a temporal sequence between two consecutive keyframes. The consecutive keyframes are consecutive according to a temporal ordering (also: time ordering) of the keyframes within the selected set of keyframes. Generating the intermediary frames is based on optimizing a perceptual (e.g., difference) metric associated with the selected set of keyframes and the generated intermediary frames. Optimizing the perceptual (e.g., difference) metric includes optimizing (e.g., minimizing) the perceptual (e.g., difference) metric as a function of values of the set of rendering parameters associated with each of the intermediary frames. The method still further includes an act of rendering an animation (also denoted as video) using the generated intermediary frames and the selected set of keyframes.

The medical image dataset included in an input may be received from a medical scanner (e.g., from a magnetic resonance imaging, MRI, scanner). Alternatively, or in addition, the medical image dataset may include a synthetic dataset received from a synthetic image generator, e.g., from a neural network (NN).

Alternatively, or in addition, one or more NNs may be used to detect structures in data, in particular in the at least one input, and/or in the medical image dataset.

Further alternatively, or in addition, the medical image dataset, and/or the detected structures, may be used to generate the keyframes. Still further alternatively, or in addition, the medical image dataset, and/or the detected structures, need not be rendered (and/or displayed), e.g., directly.

The medical image dataset may include a volumetric dataset, e.g., received from the medical scanner.

A Neural Radiance Field (NeRF) may include a, in particular fully-connected, NN. A NeRF may be used. E.g., instead of using a volumetric dataset as medical image dataset from a medical scanner, the NeRF may use one or more two-dimensional (and/or planar) images as the medical image dataset and generate novel (e.g., three-dimensional, 3D, and/or obtained from a 3D rotation of the one or more images included in the medical image dataset) views (and/or images).

Synthetic datasets with specific characteristics can be used for testing a system (and/or computing device) behavior towards those characteristics.

Practical uses of synthetic datasets further include simulation data from high performance computing applications, e.g., rather than imaging data, and/or simulation data in medical applications, e.g., blood flow and/or electrophysiological simulations of the heart, in particular a patient digital twin application.

Alternatively, or in addition, keyframes can use interpolation and/or extrapolation algorithms, e.g., including optical flow and/or machine learning (ML) approaches. Further alternatively, or in addition, artist-created data as a type of synthetic data can be used, e.g., by (and/or including) voxel sculpting.

The set of keyframes may include at least two (in particular different) keyframes.

The selecting of the set of keyframes may include selecting different predetermined values of a set of rendering parameters associated with the at least one input (and/or the at least one medical image dataset). E.g., different camera parameters (also denoted as viewing parameters and/or viewing directions) may be selected for an input (and/or for a medical image dataset), in particular received from a medical (e.g., MRI) scanner.

Alternatively, or in addition, the at least one input (and/or medical image dataset) may include two or more inputs (and/or medical image datasets). E.g., the input may include medical image datasets received at different instants in time (also denoted as moments in time, and/or points in time). For example, the medical image datasets may be acquired with a temporal separation of a few days, several weeks, several months, and/or years. Thereby, a progression of a health condition (and/or a course of disease), e.g., a growth of a tumor and/or a development of a lesion, over time may be documented and/or visualized.

Alternatively, or in addition, the at least one input (and/or medical image dataset) may include two or more inputs (and/or medical image datasets) as temporal data. E.g., an acquisition separation of medical image datasets (and/or instances of medical image datasets, briefly also: medical images) may be of the order of (e.g., a few) milliseconds. For example, the temporal data may include ultrasound data, and/or so-called cine sequences of magnetic resonance imaging (MRI) data and/or of computed tomography (CT) data, e.g., in heart scans (also denoted as cardiac scans). A cine sequence of MRI data may include a plurality of consecutive frames acquired using an MRI scanner. A frame may include, in particular medical, image data at one instant (and/or point) in time.

Alternatively, or in addition, the at least one input may include two or more input medical image datasets received from different medical scanners (briefly also denoted as scanners), and/or using different medical imaging modalities. E.g., a first medical image dataset may be received from an MRI scanner, and a second medical image dataset may be received from an ultrasound (US) scanner.

Further alternatively, or in addition, the at least one input (and/or medical image dataset) may include a two-dimensional (e.g., including two spatial dimensions and/or an image plane) medical image, e.g., a radiographic image (also denoted as X-ray image).

Still further alternatively, or in addition, the at least one input may include a three-dimensional medical image dataset. E.g., the medical image dataset may include three spatial dimensions (e.g., as a volumetric image dataset taken at one instant in time). Alternatively, or in addition, the medical image dataset may include two spatial dimensions (and/or an image plane) and a temporal (also denoted as time-like) dimension.

Still further alternatively, or in addition, the at least one input may include a four-dimensional medical image dataset. The four-dimensional medical image dataset may include three spatial dimensions and a temporal dimension.

A frame may include an image at one instant in time.

A keyframe may include a frame with a set of predetermined values of rendering parameters.

The selecting of the set of keyframes may include a temporal ordering of, and/or may be followed by an act of temporally ordering (e.g., re-ordering), the keyframes within the set. According to one embodiment, the temporal ordering of the keyframes may be performed by a human user (also denoted as human operator, or briefly as user, e.g., a medical practitioner). According to another embodiment, the temporal ordering of the keyframes may be performed by a computing device (e.g., the computing device performing the method according to the method aspect). According to a further embodiment, the two types of ordering may be combined. E.g., a human user may perform an initial temporal ordering, and the computing device may perform an (e.g., partial) re-ordering. The (e.g., partial) re-ordering may be based on optimizing a perceptual metric, e.g., the same perceptual metric as in the act of generating the intermediary frames.

Generating intermediary frames between (e.g., two consecutive) keyframes may be denoted as interpolating between the (e.g., consecutive) keyframes. Alternatively, or in addition, generating (e.g., intermediary) frames from only one keyframe (e.g., at the beginning, at the end, and/or in the middle of an animation), may be denoted as extrapolating from the keyframe.

Alternatively, or in addition, extrapolating (also denoted as: extrapolation) may refer to generating, e.g., intermediary, frames that are not included (e.g., in the selected set of keyframes) between, and/or beyond, the first and last keyframes on the timeline and that cannot be determined (and/or computed) by interpolation. Extrapolation may use one or more, or all, of the keyframes (e.g., within the selected set of keyframes).

E.g., an extrapolation may use the last two or more keyframes to construct frames after the last keyframe (e.g., within the selected set of keyframes), by fitting according to a statistical model. Alternatively, or in addition, the constructed frames and the keyframes used for the constructing may fit the statistical model.

According to one embodiment, the perceptual metric (e.g., for generating the intermediary frames, and/or for temporally ordering the keyframes) may include a perceptual difference metric. In particular, a large value of the perceptual difference metric may correspond to a large difference (also denoted as dissimilarity) of consecutive frames within the temporal sequence. Alternatively, or in addition, a small value of the perceptual difference metric may correspond to a small difference (and/or a large similarity) of the consecutive frames within the temporal sequence.

According to another embodiment, the perceptual metric (e.g., for generating the intermediary frames, and/or for temporally ordering the keyframes) may include a perceptual similarity metric. In particular, a large value of the perceptual similarity metric may correspond to a large similarity of consecutive frames with the temporal sequence. Alternatively, or in addition, a small value of the perceptual similarity metric may correspond to a large difference (and/or dissimilarity) of the consecutive frames within the temporal sequence.

The perceptual (e.g., difference) metric may be indicative of (and/or may quantize) a difference and/or dissimilarity between consecutive frames within the temporal sequence. E.g., a large value of the perceptual (e.g., difference) metric may indicate a large difference and/or a large dissimilarity between the consecutive frames.

Alternatively, or in addition, the (e.g., value of the) perceptual metric of the intermediary frames in the temporal sequence and the keyframes (e.g., at least at the boundaries of the temporal sequence) may include a sum over (e.g., individual values of) the perceptual metrics associated with consecutive frames. Alternatively, or in addition, the (e.g., value of the) perceptual metric of the intermediary frames in the temporal sequence and the keyframes (e.g., at least at the boundaries of the temporal sequence) may include an extremum (e.g., a maximum) of (e.g., values of) the perceptual (e.g., difference) metrics associated with consecutive frames.

Optimizing the perceptual (e.g., difference) metric may include minimizing (e.g., a value of) the perceptual (e.g., difference) metric of the intermediary frames in the temporal sequence and the keyframes. Alternatively, or in addition, optimizing the perceptual (e.g., similarity) metric may include maximizing (e.g., a value of) the perceptual (e.g., similarity) metric of the intermediary frames in the temporal sequence and the keyframes.

The set of keyframes may include at least the start frame and the end frame of the temporal sequence. Alternatively, or in addition, the set of keyframes may include (e.g., not generated) intermediary frames in a temporal sequence of the animation.

The generating of the intermediary frames in the temporal sequence between the two consecutive keyframes may also be denoted as interpolating between the two consecutive keyframes. Interpolating between the two consecutive keyframes may include interpolating the rendering parameters contained (and/or included) in the keyframes and rendering the intermediate frames (and/or intermediate images) accordingly.

Alternatively, or in addition, interpolating between the two consecutive keyframes may include interpolating the images at the keyframes, e.g., using an optical flow and/or a similar technique.

The generated intermediary frames in the temporal sequence may include an equal temporal (and/or time-like) separation of the intermediary frames, e.g., between two consecutive keyframes. Alternatively, or in addition, an (in particular intermediary) frame rate, e.g., between two consecutive keyframes, may be constant.

Any intermediary frame, and/or any one of the keyframes, may include a two-dimensional image for rendering. Alternatively, or in addition, a point on the timeline between the (e.g., two consecutive) keyframe times may be picked, the rendering parameters may be interpolated (e.g., between the rendering parameters of the two consecutive keyframes), and a two-dimensional (2D) image may be rendered. Further alternatively, or in addition, the frame may use data interpolation (e.g., between the, in particular volumetric, data and/or datasets of the two consecutive keyframes), in which case an interpolated, in particular three-dimensional (3D), dataset (and/or image) may be associated with the new frame.

The animation may include the selected set of keyframes according a (e.g., predetermined and/or updated) temporal ordering as well as the generated intermediary frames in the temporal sequence.

The temporal sequence may include (and/or may be split into) multiple temporal sub-sequences, e.g., if the set of keyframes includes at least three keyframes. Alternatively, or in addition, any set of keyframes including three or more keyframes may include one keyframe as the start of the animation, another keyframe as the end of the animation, and one or more keyframes in the middle of the animation. Alternatively of in addition, the temporal sequence may include a temporal sub-sequence between any pair of consecutive keyframes.

The rendering may include displaying the animation of the generated intermediary frames in the temporal sequence and the keyframes (e.g., at least at the boundaries of the temporal sequence) on a screen, and/or on a head-mounted display (HMD).

Alternatively, or in addition, an intermediate frame from the animation may be used (and/or rendered) as a standalone image showing a state between two (e.g., consecutive) keyframes.

Further alternatively, or in addition, rendering may include using lightfield and/or autostereoscopic displays, and/or Augmented Reality (AR) systems (e.g., including one or more large displays with head-tracking, and/or tracked tablets). Still further alternatively, or in addition, the rendering may include using an AR headset, and/or a Virtual Reality (VR) headset. Alternatively, or in addition, Extended Reality (XR) may include AR and/or VR (and/or an XR headset may include an AR headset and/or a VR headset).

The rendering may include differentiable rendering (DR). DR may model the explicit relationship between rendering parameters and resulting images in conventional image synthesis. In DR, image-space derivatives with respect to the rendering parameters may be obtained, which can be used in a variety of gradient-based optimization methods, e.g., to solve inverse rendering problems, or to compute the loss for training ML models directly in the space of rendered images.

DR may be used to implement the technique, e.g., by driving the rendering parameter changes (and/or the interpolation of the values of the rendering parameters) when generating (also: creating) the intermediary frames based on the perceptual metric (and/or the perceptual differences, and/or the perceptual similarities) between the generated (e.g., intermediary) images (and/or intermediary frames including the images).

Optical flow and/or ML based algorithms (also denoted as ML algorithms, ML approaches, and/or ML models) may be used to interpolate the rendered images, e.g., by generating (and/or creating) more or less intermediate frames (e.g., including the images) based on the perceptual (e.g., difference) metric.

Alternatively, or in addition, optical flow and/or ML based algorithms may be used to interpolate the medical images. E.g., for imaging of a beating heart with CT, MR and/or ultrasound, interpolated medical images may be generated for each intermediate frame from a four-dimensional (4D) medical image sequence.

Alternatively, or in addition, the technique may be used together with a variety of rendering algorithms, including, but not limited to, photorealistic volume rendering, real-time (in particular direct) volume rendering (e.g., in particular fast volume, ray casting), mesh-based rendering and/or neural rendering.

Optimizing the perceptual metric may be gradient-based. Alternatively, or in addition, the rendering parameters in the frames (e.g., the intermediary frames, and/or the keyframes, in particular if the keyframes are temporally ordered) may be optimized based on a perceptual difference of the resulting rendered frames.

Further alternatively, or in addition, determining (e.g., computing) the optimal frames (e.g., the intermediary frames, and/or the keyframes, in particular if the keyframes are temporally ordered) may use gradient-based optimization.

The (in particular computer-implemented) technique may be applied for clinical diagnosis, e.g., by providing a visual representation of a health condition and/or a pathology to a medical practitioner (e.g., a surgeon and/or an oncologist). Alternatively, or in addition, the (in particular computer-implemented) technique may be applied for planning a therapeutic treatment, and/or for planning a surgical intervention.

While there is a significant body of work on animation control, the technique specifically focuses on solving the problem of computing optimized keyframe timing automatically. Liu and Cohen describe a system that computes the pacing for a sequence of keyframes based on specified constraints and an optimization process. In contrast, by the technique herein, the optimization process may be fully automated, in particular based on DR and perceptual metrics of the rendered images (and/or frames, e.g., including the keyframes and generated intermediary frames).

Liu and Cohen present a motion optimization algorithm for keyframe-based animations, where the user specifies the desired keyframes together with some constraints (e.g., a maximal velocity of a hand motion), and the system computes an optimized set of keyframe parameters that satisfy those constraints (e.g., keyframe timing is relaxed so that the hand velocity doesn't exceed the specified constraint).

By contrast, the optimization loop of the technique incorporates the rendering act and allows the (e.g., key- and/or intermediary) frame optimization to be driven by image-space metrics (and/or perceptual metrics, e.g., by image-space gradients with respect to rendering parameters with DR, and/or perceptual image differences with respect to timing and/or rendering parameters). The technique is especially important for the animations of medical images (also denoted as medical visualization animations) that cannot be modelled as motions and physical movement constraints (e.g., as classification and/or lighting changes), and/or when the physical motion does not correspond directly to visible image changes (e.g., a moving clip plane through inhomogeneous data).

In contrast, the optimization in Liu and Cohen does not account for the effects of the physical motion on the rendered image and is performed entirely before rendering happens. The optimization loop of has a human user manually editing the animation after observing the results of each optimization pass.

The perceptual metric may include a perceptual hash (pHash), a structural similarity, a visual entropy, and/or a blend reference image spatial quality evaluator (BRISQUE).

The pHash may include a locality-sensitive hash (LSH). Alternatively, or in addition, the pHash may be indicative of (and/or may quantify) a similarity between (e.g., consecutive in time) images, and/or between consecutive frames.

An algorithm for determining the pHash may include image modification, e.g., compression, color correction and/or brightness. E.g., for a color image, a gray scale image may be determined. Alternatively, or in addition, a resolution of an image may be scaled down, e.g., in terms of a number of pixels.

Alternatively, or in addition, the pHash may be determined based on a Hamming distance of consecutive images, and/or consecutive frames. E.g., the Hamming distance may include a counting of bits (and/or pixels) that differ from one image to the next image.

The pHash may be determined for any pair of consecutive frames. Alternatively, or in addition, the pHash may be cumulative, e.g., by summing over the pHashes of all pairs of consecutive frames between two consecutive keyframes.

The result of the comparison of (e.g., two consecutive) images and/or frames may be a metric-specific value that indicates some amount of difference and/or similarity. In some embodiments, the result may be normalized, e.g., the range of 0 . . . 1 (e.g., with the value 0 indicating identity according to a perceptual difference metric). In some other embodiments, the result need not be normalized (and/or a normalization may not be possible), but a threshold value of an acceptable similarity (and/or dissimilarity) may be employed before starting to generate (e.g., more) intermediate frames. E.g., an intermediary frame may be promoted to a keyframe of an expanded set of keyframes in case of a dissimilarity exceeding a dissimilarity threshold value, and the act of generating intermediary frames may be repeated for the newly promoted keyframe and its neighboring (e.g., preceding and/or subsequent) keyframes.

A (e.g., direct) pixel-to-pixel comparison (e.g., using root mean square error, RMSE, and/or peak signal-to-noise ratio, PSNR) and/or pHash may be the simplest and/or most absolute way to compare images, and/or frames. Alternatively, or in addition, the images (and/or frames) need not be perceived as individual pixels, e.g., instead it may be looked (e.g., for the perceptual, in particular difference, metric, and/or for the comparison) for structures and patterns in (e.g., two consecutive) images. Further alternatively, or in addition, statistical similarity measurements, e.g., using ISSM, may be used for the comparison of the (e.g., two consecutive) images.

PHash metrics (or briefly: pHashes) are conventionally designed to pick out (in particular types and/or kinds of) differences (and/or dissimilarities) that a human vision system would be more perceptible to, e.g., as compared to other (in particular types and/or kinds of) differences in images (and/or frames) conventionally not captured by a human observer. The (in particular types and/or kinds of) differences picket out by the pHash may or may not (and/or need not), weigh all pixel-to-pixel changes equally.

A perceptual metric may use a multi-scale comparison, e.g., by scaling down a resolution and/or a number of pixel representing any one of the images before comparing them.

According to some embodiments, an image is scaled down as a part of a perceptual image comparison (and/or a value of the perceptual metric is determined), when the scale down process is performed (e.g., four pixels are combined to one pixel), individual pixel information may be lost, but the resultant pixel image (e.g., the, in particular pixel-wise, comparison of scaled down images) may be a better representation of the overall difference of the images in the four pixels when combined together into one pixel.

The structural similarity (also denoted as structural similarity index measure, SSIM) may be indicative of (and/or may quantify) a similarity between (e.g., consecutive in time) images, and/or between consecutive frames.

The structural similarity may include a full reference metric, and/or may be based on an uncompressed and/or distortion-free image as reference. E.g., among two consecutive frames, the first (and/or earlier within the temporal sequence) frame may include the reference image. The structural similarity may be determined by comparing the image of the second (and/or later within the temporal sequence) frame with the reference image.

E.g., the structural similarity of two images (and/or frames) x and y may be determined as a weighted product of a luminance l(x,y), contrast c(x,y), and structure s(x,y):

$$SSIM = {l ( x , y )}^{α} {c ( x , y )}^{β} {s ( x , y )}^{γ} , e . g . , with$$

$$l ( x , y ) = \frac{2 {μ}_{x} {μ}_{y} + {c}_{1}}{{μ}_{x}^{2} + {μ}_{y}^{2} + {c}_{1}} ; c ( x , y ) = \frac{2 {σ}_{x} {σ}_{y} + {c}_{2}}{{σ}_{x}^{2} + {σ}_{y}^{2} + {c}_{2}} ; s ( x , y ) = \frac{{σ}_{xy} + {c}_{3}}{{σ}_{x} {σ}_{y} + {c}_{3}} ,$$

and with μₓ the pixel sample mean of x, μ_{y} the pixel sample mean of y, σₓ² the variance of x, σ_{y}² the variance of y, σ_{xy} the covariance of x and y, and constants c₁, c₂ and c₃ (e.g., depending on a dynamic range of pixel-values of the images x and y, and/or in particular with c₃=c₂/2) for stabilization of the divisions with a weak denominator. The weights α, β and γ may be in the range between 0 and 1. More details on (e.g., multiscale) structural similarity can be found in Z. Wang et al., “Multiscale structural similarity for image quality assessment,”The Thirty-Seventh Asilomar Conference on Signals, Systems and Computers, 2003. Vol. 2. pp. 1398-1402.

Alternatively, or in addition, the technique may use one or more conventional image similarity metrics, combinations of metrics, and/or ML approaches to compare images. In a practical sense, some metrics may provide better performance with certain types of rendering, e.g., pHash and/or BRISQUE for photorealistic rendering, and/or SSIM for illustrative rendering.

The visual entropy may include a measure for the amount of information included in an image (and/or a frame). The visual entropy may in particular increase with a visual complexity of the image (and/or the frame). Alternatively, or in addition, the visual entropy may be indicative of an incompressibility of the image (and/or the frame). E.g., the visual entropy may increase with the number of bits required for coding the information included in the image (and/or the frame).

The BRISQUE may include a score based on extracting natural scene statistics and determining feature vectors. Alternatively, or in addition, BRISQUE may include a no reference image quality assessment (NR-IQA) algorithm.

The perceptual metric may be based on determining a difference of a quantification of one image (and/or frame) and a quantification of the neighboring (e.g., preceding and/or subsequent in the temporal sequence) image (and/or frame). E.g., the perceptual metric may include a difference of visual entropies of consecutive images (and/or frames). Alternatively, or in addition, the perceptual metric may include a difference of BRISQUE scores of consecutive images (and/or frames).

Neighboring images may include consecutive images. Alternatively, or in addition, the neighboring image may refer to either the first (also denoted as preceding) or the second (also denoted as subsequent) image within a pair of consecutive images.

Alternatively, or in addition, the perceptual metric may be based on a quantification of a difference, in particular of consecutive images (and/or frames). E.g., the pHash and/or the structural similarity may be defined as a difference (and/or change) of consecutive images (and/or frames).

The at least one input may include a two-dimensional (2D) medical image dataset, a three-dimensional (3D) medical image dataset, and/or a four-dimensional (4D) medical image dataset.

The two-dimensional medical image dataset may include a planar image. Alternatively, or in addition, the three-dimensional medical image dataset may include a volumetric image. Further alternatively, or in addition, the four-dimensional medical image dataset may include a volumetric image evolving over time.

Still further alternatively, or in addition, the three-dimensional medical image dataset may include a temporal sequence of two-dimensional images (also denoted as a two-dimensional and/or planar image evolving over time).

The at least one medical image dataset may be received from a medical scanner.

The medical scanner may include a device associated with a medical imaging modality.

The medical imaging modality may include magnetic resonance imaging (MRI), radiography (also denoted as X-rays), ultrasound (US), echocardiography, computed tomography (CT), and/or single-photon emission computed tomography (SPECT).

Alternatively, or in addition, the medical scanner may include an MRI device, an X-ray device, a US device, an echocardiograph, a CT device, and/or a SPECT device.

According to some embodiments, the at least one medical image dataset may include at least two different medical image datasets obtained from at least two different medical scanners.

The at least two different medical scanners may include scanners associated with at least two different scanning modalities. E.g., at least one keyframe may correspond to (and/or include) an MRI image dataset, and at least one further keyframe may correspond to (and/or include) a CT image dataset.

Alternatively, or in addition, the at least two different medical scanners may include at least two different scanners using the same scanning modality. E.g., the at least two different medical scanners may include two different CT scanners (and/or two different MRI scanners). The scanners may differ in terms of their scanning parameters, e.g., two different MRI scanners may use different magnetic field strengths.

Alternatively, or in addition, the at least two different medical scanners may provide medical image datasets with different resolutions.

The set of rendering parameters may include at least one rendering parameter, in particular a camera parameter, a clipping parameter, a classification parameter (also denoted as classification preset), and/or a lighting preset parameter (briefly also: lighting parameter, and/or lighting preset).

The at least one camera parameter (also: viewing parameter) may include one or more extrinsic camera parameters, e.g., defining a location and/or an orientation of a (e.g., virtual) camera and/or a viewer. Alternatively, or in addition, the at least one camera parameter may include one or more intrinsic camera parameters, e.g., enabling a mapping between camera coordinates and pixel coordinates of an image (and/or a frame).

The at least one clipping parameter may encode a clipping (also denoted as cutting-out) of features (e.g., parts of an anatomical structure) from the at least one medical image dataset, in particular for the rendering. E.g., a clipping parameter may specify a section of a human skull (as an example of a feature) to be cut out of the rendered image. Thereby, structures inside the skull, in particular parts of the brain, may be visible in the rendered image.

The at least one classification parameter may include a classification of tissue and/or of anatomical structures, e.g., per pixel. Alternatively, or in addition, the at least one classification parameter may correspond to or may include an anatomical segmentation of the medical image dataset. Further alternatively, or in addition, the at least one classification parameter may include a transfer function, and/or a windowing.

The at least one lighting preset parameter (briefly also lighting parameter) may include a direction of a light source, and/or a shape of a light source. E.g., a light source may be planar, point-like or spherical. Alternatively, or in addition, the light source may be situated, e.g., towards any side from, and/or in direction of, the view point of an observer.

The set of rendering parameters may include any further rendering parameter that can affect the rendered image (also denoted as scene).

The method may further include an act of temporally ordering the keyframes within the selected set of keyframes. Optionally, the temporal ordering may be based on optimizing a perceptual metric.

An initial temporal ordering may be performed by a human operator (also denoted as human user, or briefly as user). Alternatively, or in addition, an initial temporal ordering may be based on an order, in which the selected keyframes are received.

The keyframes may be temporally ordered, and/or an initial temporal ordering may be changed, based on optimizing a perceptual metric applied exclusively to the set of keyframes. The perceptual metric used for temporally ordering (and/or re-ordering) the set of keyframes may be the same perceptual metric as used in the act of generating intermediary frames.

Alternatively, or in addition, the perceptual metrics of the act of temporally ordering the set of keyframes and of the act of generating intermediary frames may be independently chosen. In particular, the perceptual metric of the act of temporally ordering the set of keyframes may be different from the perceptual metric of the act of generating intermediary frames.

An initial temporal ordering may be modified if a value of the perceptual (e.g., difference) metric for the temporal ordering reaches, and/or exceeds, a predetermined threshold value indicative of a perceptual dissimilarity.

A length of a time interval between consecutive intermediary frames may be constant between two consecutive keyframes.

A time interval between consecutive (e.g., intermediary, and/or key) frames is (and/or may be) the inverse of (and/or inversely proportional to) a frame rate. The frame rate may also be denoted as frame frequency rate, frame frequency, or frequency rate. The frame rate may be fixed, and/or variable.

A keyframe rate may be proportional to a video (and/or animation) frame rate, e.g., with one keyframe every second, and/or one keyframe for every ten (10) rendered (in particular mostly intermediary) frames. Alternatively, or in addition, the keyframe rate may be variable and/or independent of the video (and/or animation) frame rate.

The frame rate may be provided (and/or measured) in frames per second (FPS), and/or in Hertz (Hz). E.g., a frame rate for cinema or TV content may be in the range of 24 FPS or 25 FPS and/or 50 FPS or 60 FPS, depending on a world region. Alternatively, or in addition, for animations of medical images (also denoted as medical videos), in particular according to the technique, the frame rate may include, e.g., between 4 FPS and 240 FPS, in particular in the range of 10 FPS and 60 FPS (e.g., 10 FPS, 12 FPS, 15 FPS, 24 FPS, 30 FPS, and/or 60 FPS).

The time interval between consecutive frames may be inversely proportional to the speed of the animation. Alternatively, or in addition, the frame rate may be proportional to the speed of the animation. The speed of the animation (and/or the frame rate) may be constant between one keyframe and the next (and/or consecutive) keyframe. Alternatively, or in addition, the speed of the animation (and/or the frame rate) may differ from one pair of consecutive keyframes to another pair of consecutive keyframes. E.g., a first speed of the animation (and/or a first frame rate) may apply to a part of the animation starting with a first keyframe and ending with a second keyframe. A second speed of the animation, which may be different (e.g., slower or faster) from the first speed of the animation, (and/or a second frame rate, which may be different, e.g., slower or faster, from the first frame rate) may apply to a part of the animation starting with the second keyframe and ending with a third keyframe. The naming of the first keyframe, second keyframe and third keyframe may correspond to a temporal ordering of the respective keyframes.

A first length of a time interval (and/or a first frame rate) between a first set of consecutive intermediary frames associated with a first pair of consecutive keyframes (e.g., including the first keyframe and the second keyframe) may be independent of a second length of a time interval (and/or a second frame rate) between a second set of consecutive intermediary frames associated with a second pair of consecutive keyframes (e.g., including the second keyframe and the third keyframe). The second pair of consecutive keyframes may differ from the first pair of consecutive keyframes.

A length of a time interval (and/or a frame rate) between consecutive intermediary frames associated with the pair of consecutive keyframes may depend on a value of a perceptual metric between the keyframes within the pair of consecutive keyframes. E.g., a large value of a perceptual difference metric may be indicative of a large difference in the keyframes, and in order to smoothen the animation, a length of the time interval between the keyframes may be increased, e.g., by generating a large (or larger) number of intermediary frames (e.g., iteratively by promoting one or more initially generated intermediary frames to further keyframes and repeating the act of generating intermediary frames with the expanded set of keyframes).

Alternatively, or in addition, a number of intermediary frames associated with a pair of consecutive keyframes may depend on a value of a perceptual metric between the keyframes within the pair of consecutive keyframes.

Optionally, a number of generated intermediary frames may increase with a value of the perceptual (e.g., difference) metric.

The length of a time interval between consecutive intermediary frames (and/or a frame rate) may be kept constant while at the same time reducing the speed of the animation by generating a larger number of intermediary frames.

The act of generating the intermediary frames in the temporal sequence may further include extending a length of a time interval between at least one pair of consecutive keyframes (briefly also: between consecutive keyframes) within the selected set of keyframes (and/or reducing a keyframe rate associated with the at least one pair of consecutive keyframes within the selected set of keyframes). E.g., the selected set of keyframes may be associated with a constant length of a time interval between consecutive keyframes (and/or a constant keyframe rate). Alternatively, or in addition, the act of generating the intermediary frames associated with the (e.g., originally) selected set of keyframes may include generating a predetermined number of intermediary frames between consecutive keyframes. Alternatively, or in addition, a predetermined (e.g., intermediary) frame rate may be applied for rendering.

Alternatively, or in addition, the act of generating the intermediary frames in the temporal sequence may further include expanding the selected set of keyframes by promoting one or more intermediary frames to keyframes, which may be added to the selected set of keyframes to form an expanded set of keyframes. The one or more intermediary frames, which are to be promoted to keyframes of the expanded set of keyframes, may in particular be associated with the at least one pair of consecutive keyframes, for which the length of the time interval has been extended (and/or for which the keyframe rate has been reduced).

The act of generating the intermediary frames in the temporal sequence may be repeated for the expanded set of keyframes.

The extending of the length of the time interval between the (e.g., at least one pair of) consecutive keyframes may also be denoted as modifying, and/or moving, a timeline between (e.g., original) keyframes.

The extending of the length of the time interval between the (e.g., at least one pair of) consecutive keyframes, and/or the modifying, and/or the moving, of the timeline may be based on a value of the perceptual (e.g., difference and/or similarity) metric of the (e.g., respective) consecutive keyframes. E.g., one or more intermediary frames between the (e.g., respective) consecutive keyframes may be promoted to a keyframe of the expanded set of keyframes, if the perceptual metric is indicative of the (e.g., respective) consecutive keyframes reaching, and/or exceeding, a predetermined threshold value indicative of a perceptual dissimilarity.

Repeating the act of generating the intermediary frames in the temporal sequence (and/or interpolating between the keyframes) for the expanded set of keyframes may include modifying the generating (also denoted as generation) of the (e.g., associated and/or optimized) values of the set of rendering parameters.

E.g., the generating, and/or the optimizing, of the values of the set of rendering parameters per intermediary frame may include (e.g., constrained) spline interpolation, and/or linear interpolation.

Spline interpolation may utilize a piecewise polynomial, denoted as spline, as interpolant.

By expanding the set of keyframes, a smoothness of the perception of the animation may be improved, and/or a perceptual error may be reduced. E.g., when changing the camera parameter (and/or, e.g., a viewing direction) relative to a partial clipping of an anatomical structure, abrupt changes at the boundaries of the clipping in the rendered animation may be mitigated.

The expanding of the set of keyframes may include a manual selection of one or more intermediary frames to be promoted to keyframes. Alternatively, or in addition, the expanding of the set of keyframes may be performed without manual input, and/or fully automatically, e.g., based on a limitation of optimizing the perceptual metric (e.g., the perceptual, in particular difference, metric exceeding a predetermined threshold before the expansion of the set of keyframes).

Alternatively, or in addition, the act of generating the intermediary frames in the temporal sequence may be performed iteratively, e.g., new intermediary frames may be generated after adding a further keyframe (e.g., a promoted intermediary frame) to the expanded set of keyframes.

The number of additionally generated intermediary frames may depend on a value of the perceptual metric between the newly added keyframe and the neighboring (e.g., preceding, and/or consecutive) keyframe.

Alternatively, or in addition, a length of a time interval among the additionally generated intermediary frames may depend on a value of the perceptual metric between the newly added keyframe and the neighboring (e.g., preceding, subsequent and/or consecutive) keyframe.

The promoting of one or more intermediary frames to keyframes may be performed (e.g., only) if the perceptual (e.g., difference) metric between consecutive intermediary frames including the to-be-promoted one or more intermediary frames reaches, and/or exceeds, a predetermined threshold indicative of a perceptual difference (and/or dissimilarity). Alternatively, or in addition, the promoting of one or more intermediary frames to keyframes may be performed (e.g., only) if the perceptual (e.g., similarity) metric between consecutive intermediary frames including the to-be-promoted one or more intermediary frames reaches, and/or falls below, a predetermined threshold indicative of a perceptual similarity.

The at least one input (and/or medical image dataset) may include one or more animations. The one or more animations received as input may be included in the rendered animation.

The input (and/or medical image dataset), and/or the selected set of keyframes may include (and/or contain) at least one annotation.

The one or more annotation may include a textual annotation, a geometric annotation, a shading, and/or an anatomical segmentation.

Alternatively, or in addition, the one or more annotation may include a measurement and/or a measurement result, e.g., as an embedded ruler with a marking and/or text label.

A technique for the rendering may include DR. Alternatively, or in addition, the technique may utilize one or more ML algorithms.

The method may be performed by a NN, in particular including a convolutional neural network (CNN). Alternatively, or in addition, the method may be performed using artificial intelligence (AI).

The NN, and/or any AI, may be trained on a number of inputs (and/or medical image datasets) received during a training phase. The training phase may be supervised, partly supervised, or unsupervised. E.g., a rendered animation may be accepted or rejected by a human observer and/or by a, e.g., dedicated NN (e.g., including a discriminator, and/or a generative adversarial network, GAN).

Alternatively, or in addition, in an inference phase, the NN, and/or the AI, may perform the method supervised and/or fully automated.

In an embodiment, the NN, and/or the AI (and/or the, e.g., AI, model), may be trained based on a perceptual error (and/or based on values of a perceptual metric) generated from animation of different, in particular rendering, parameters (e.g., applied to the same medical image dataset and/or volumetric dataset). The NN, AI, and/or model may be deployed to resource limited systems, to generate animations from arbitrary sets of keyframes without expensive image comparisons.

Alternatively, or in addition, the NN, AI, ML algorithm, and/or any other model may be trained by reinforcement learning.

Alternatively, or in addition, metric learning may be utilized by the NN, AI, ML algorithm, and/or any other model. By the metric learning, a similarity metric (and/or a perceptual, e.g., similarity metric) may be learnt from weakly supervised data (e.g., including the at least one input, and/or the medical image dataset), in particular as opposed to manually crafted features or math. Metric learning may replace the image comparison (and/or the determining of a perceptual metric of consecutive frames, in particular of intermediary frames and/or keyframes) of the technique.

As to a device aspect, a computing device (computer) for rendering animations of medical images is provided. The computing device includes a receiving unit (interface) configured for receiving at least one input. Each of the at least one input includes a medical image dataset. The computing device further includes a selecting unit configured (or is configured) for selecting a set of keyframes associated with the received at least one input. A keyframe includes predetermined values of a set of rendering parameters (e.g., one predetermined value per rendering parameter, and/or a predetermined value for at least one selected rendering parameter). The computing device further includes a generating unit configured (or is configured) for generating intermediary frames in a temporal sequence between two consecutive keyframes. The consecutive keyframes are consecutive according to a temporal ordering (also: time ordering) of the keyframes within the selected set of keyframes. Generating the intermediary frames is based on optimizing a perceptual (e.g., difference) metric associated with the selected set of keyframes and the generated intermediary frames. Optimizing the perceptual (e.g., difference) metric includes optimizing (e.g., minimizing) the perceptual (e.g., difference) metric as a function of values of the set of rendering parameters associated with each of the intermediary frames. The computing device still further includes a rendering unit (renderer or graphics processing unit) configured for rendering an animation using the generated intermediary frames and the selected set of keyframes.

The computing device may further include a temporally ordering unit configured (or is configured) for temporally ordering the keyframes within the selected set of keyframes. Optionally, the temporal ordering may be based on optimizing a perceptual metric.

The computing device may be configured for performing the method according the method aspect.

As to a system aspect, a medical viewing system for rendering animations of medical images is provided. The medical viewing system includes a computing device according to the device aspect and a display for displaying the rendered animation.

As to a further aspect, a computer program product is provided including program elements which induce a computing device (and/or a server) to carry out the acts of the method for rendering animations of medical images according to the method aspect, when the program elements are loaded into a memory of the computing device (and/or the server).

As to a still further aspect, a non-transitory computer-readable medium is provided, on which program elements are stored that can be read and executed by a computing device (and/or a server), in order to perform acts of the method for rendering animations of medical images according to the method aspect, when the program elements are executed by the computing device (and/or the server).

The properties, features and advantages described above, as well as the manner they are achieved, become clearer and more understandable in the light of the following description and embodiments, which will be described in more detail in the context of the drawings. This following description does not limit the invention on the contained embodiments. Same components or parts can be labeled with the same reference signs in different figures. In general, the figures are not for scale.

It shall be understood that a preferred embodiment can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

FIG. 1 is a flow chart of a method according to a preferred embodiment;

FIG. 2 is an overview of the structure and architecture of the computing device according to a preferred embodiment;

FIGS. 3A to 3G illustrate an optimized ordering of keyframes in medical image dataset including a human pelvis and hip joints;

FIGS. 4A and 4B show an example of creating, by a user interface, a temporally ordered set of keyframes in FIG. 4B from a comprehensive set of keyframes including a plurality of different combinations of predetermined values of rendering parameters, in particular classification and camera parameters, of a medical image dataset, some of which are displayed in FIG. 4A; and

FIGS. 5A to 5D sown an example of an AI-based liver, lesions, and vessels segmentation to synthesize clinically relevant views of patient data for oncological support without user intervention.

### DETAILED DESCRIPTION

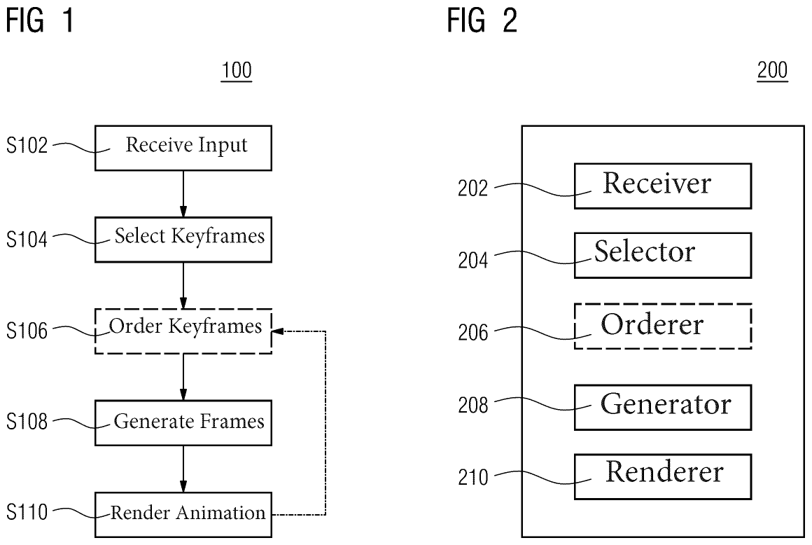

FIG. 1 shows an exemplary flowchart of a computer-implemented method for rendering animations of medical images. The method is generally denoted by reference sign 100.

In an act S102, at least one input is received. Each of the at least one input includes a medical image dataset.

In an act S104, a set of keyframes associated with the received S102 at least one input is selected. A keyframe includes predetermined values of a set of rendering parameters.

In an act S108, intermediary frames are generated in a temporal sequence between two consecutive keyframes. The consecutive keyframes are consecutive according to a temporal ordering of the keyframes within the selected S104 set of keyframes. Generating S108 the intermediary frames is based on optimizing a perceptual (e.g., difference) metric associated with the selected S104 set of keyframes and the generated S108 intermediary frames. Optimizing the perceptual (e.g., difference) metric includes optimizing (e.g., minimizing) the perceptual (e.g., difference) metric as a function of values of the set of rendering parameters associated with each of the intermediary frames.

In an act S110, an animation is rendered using the generated S108 intermediary frames and the selected S104 set of keyframes.

Optionally, the method 100 further includes an act S106 of temporally ordering the keyframes within the selected S104 set of keyframes. Further optionally, the temporal ordering S106 is based on optimizing a perceptual metric.

The perceptual metrics of the act S106 of temporally ordering the keyframes and of the act S108 of generating intermediary frames may e.g., be independently chosen of one another.

The method 100 may include an optimization loop from the act S110 back to the act S106 (e.g., as indicated by the dash-dotted line in FIG. 1) that may be executed until constraints on the animation are met.

As a simple concrete non-limiting embodiment, the method 100 may include optimizing a keyframe (e.g., temporal) ordering in the act S106, relaxing a keyframe timing (e.g., change a time interval, and/or a frame rate, between two consecutive keyframes) in the act S108, and rendering the animation in the act 110, and (e.g., re-) computing pHash image differences (as example of using a perceptual difference metric). If perceptual difference between rendered images is greater than a predetermined threshold, the act S106 of optimizing the keyframe ordering may be repeated, in particular followed by repeating the acts S108 and S110 until the perceptual difference between the rendered images falls below the predetermined threshold.

FIG. 2 shows an exemplary computing device for rendering animations of medical images. The computing device is generally denoted by the reference sign 200.

The computing device 200 includes a receiving unit 202 (interface or other receiver) configured for receiving at least one input. Each of the at least one input includes a medical image dataset.

The computing device 200 further includes a selecting unit 204 (selector) configured (or is configured) for selecting a set of keyframes associated with the received at least one input. A keyframe includes predetermined values of a set of rendering parameters.

The computing device 200 further includes a generating unit 208 (generator) configured (or is configured) for generating intermediary frames in a temporal sequence between two consecutive keyframes. The consecutive keyframes are consecutive according to a temporal ordering of the keyframes within the selected set of keyframes. Generating the intermediary frames is based on optimizing a perceptual (e.g., difference) metric associated with the selected set of keyframes and the generated intermediary frames. Optimizing the perceptual (e.g., difference) metric includes optimizing (e.g., minimizing) the perceptual (e.g., difference) metric as a function of values of the set of rendering parameters associated with each of the intermediary frames.

The computing device 200 still further includes a rendering unit 210 (renderer or graphics processing unit) configured (or is configured) for rendering an animation using the generated intermediary frames and the selected set of keyframes.

Optionally, the computing device 200 further includes a temporally ordering unit 206 (orderer) configured (is configured) for temporally ordering the keyframes within the selected S104 set of keyframes. Further optionally, the temporal ordering S106 is based on optimizing a perceptual metric.

The computing device 200 may be configured to perform the method 100.

Creating compelling and clinically relevant animations for case review, diagnosis, therapy planning, and/or surgical planning is conventionally challenging. By the technique, the rendering of an animation (also denoted as the storyboarding process) is automated (in particular computer-implemented) by optimizing the keyframe order and/or keyframe timing, in particular without user intervention.

In particular, three-dimensional (3D) medical imaging (e.g., included in the at least one input, and/or the medical image dataset) may be used in clinical applications, where views are synthesized based on an anatomical segmentation.

The technique can produce effective animations for case review, diagnosis, therapy planning, and/or surgical planning, where minimalistic transitions between the clinically relevant views enhance the spatial understanding through motion parallax and/or temporal coherence.

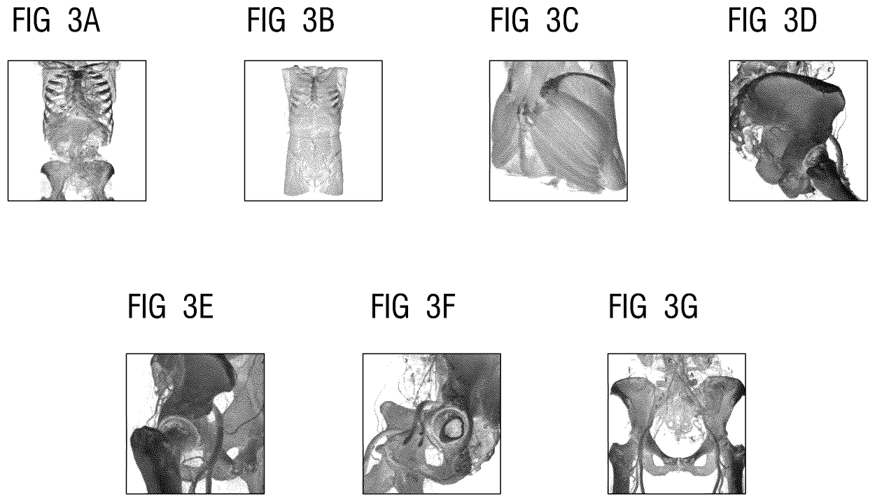

FIGS. 3A to 3G illustrate an optimized ordering of the rendered views (and/or an optimized ordering of the keyframes, which may also be denoted as optimized keyframe sequence) in a hip, pelvis and/or joints medical image dataset (and/or snapshots) collection, which result in an animation (also denoted as final video) devoid of rapid (and/or abrupt) visual changes.

In FIG. 3A, the bone structure of a human torso is shown in a front view including the thorax and pelvis area. FIG. 3B shows the human torso in the front view with soft tissue (e.g., may blood vessels, tendons, and/or muscle tissue) partially occluding the bone structure. FIG. 3C shows a rotated rear/side view of the right pelvis and hip joint area including soft tissue. FIG. 3D shows only the bone structure of the rear/side view of FIG. 3C. FIG. 3E shows a rotated front/side view of the right pelvis and hip joint of FIG. 3D. FIG. 3F shows a further rotated and/or detailed view of the bone structure of the right pelvis and hip joint of FIGS. 3D and 3E. In FIG. 3F, the right hip joint is clipped using a clip plane to show the structures behind, specifically the interior of the femoral head and/or ball of the hip joint (and/or the part of the femur bone that connects it to the pelvis). FIG. 3G shows a front view of the pelvis area including both right and left hip joint areas. In FIG. 3G, again only the bone structure is shown.

An exemplary embodiment of the technique includes the following components (e.g., included in the computing device 200): a 3D volume renderer (e.g., embodied by the rendering unit 210); a medical views (and/or medical image dataset) and/or keyframe authoring system (e.g., embodied by the receiving unit 202); a keyframe animation system (e.g., embodied by the generating unit 208); and interfaces to keyframe and animation timeline optimization processes (e.g., embodied by the temporal ordering unit 206), including feedback with in-the-loop rendering and computation of one or more image and/or video quality metrics (e.g., as perceptual metric).

Some embodiments may further employ an anatomical segmentation of 3D medical images (e.g., included in the one or more medical image dataset). Alternatively, or in addition, further embodiments may further employ an automated keyframe synthesis.

A basic implementation of the animation authoring system may rely on clinical experts to create relevant medical views (e.g., included in the one of more medical image datasets) for a clinical use, including but not limited to loading one or more 3D or 3D+time (alternatively denoted as four-dimensional, 4D) patient images; applying and modifying camera, clipping, classification and/or lighting presets (e.g., included in the set of rendering parameters); and/or saving and organizing a collection of medical views and/or keyframes (e.g., included in the at least one input, and/or in the medical image dataset).

The user may be further responsible for assembling an animation storyboard by placing the keyframes on a timeline. Each keyframe includes parameter animation tracks (e.g., within the set of rendering parameters) which the animation system (e.g., embodied by the generating unit 208) interpolates to produce intermediary frames at certain intervals for the animation (and/or the final video).

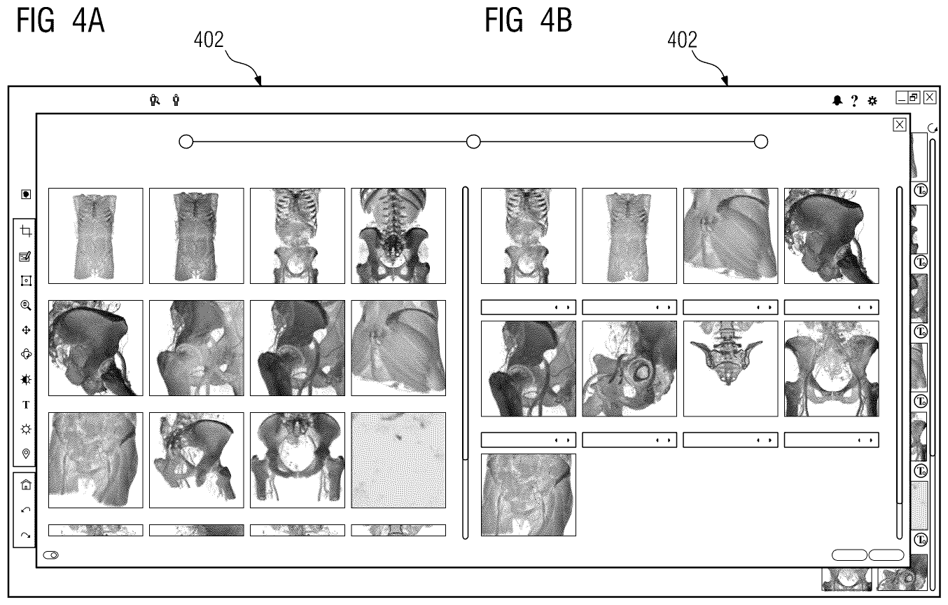

The keyframe animation capabilities may vary widely between animation systems. The exemplary application in FIGS. 4A and 4B may store the (e.g., full) set of rendering parameters and automatically generate parameter animation tracks to achieve the following animation effects:
Spline interpolation of camera pose, clip plane movements, light orientation, and/or windowing;
Blending of light probes and voxel classification;
Automated fade effects for features toggled between keyframes, including clip planes, classification effects, masking, and painting; fade animations may also be generated for volume data changes.
   An example timeline editing allows for any one, or both, the keyframe order and the timing to be modified. More comprehensive animation packages may allow for individual control of animation tracks, possibly at the cost of increased authoring complexity.

FIG. 4A shows an exemplary display on a (e.g., graphical) user interface (UI, and/or GUI) 402 of parts of an exemplary comprehensive set of keyframes (also denoted as, e.g., collection of, existing medical views) including a plurality of rendered images (and/or medical views) with different values of rendering parameters (e.g., different values for one or more classification parameters, and/or for one or more camera parameters) for a medical image dataset, e.g., with all medical views of FIGS. 3A to 3G in the comprehensive set of keyframes. FIG. 4B shows a further display on the UI (and/or GUI) 402, in which a user has manually authored (and/or selected) a storyboard (and/or a temporal ordering of keyframes within a set of selected keyframes) using the comprehensive set of keyframes. In the example of FIG. 4B, the selected set of keyframes includes all medical views from

FIGS. 3A to 3G, with two further keyframes including medical views between FIGS. 3F and 3G as well as after FIG. 3G additionally selected.

According to an embodiment, the keyframes are generated automatically from anatomical segmentations and clinical template specifications without user intervention.

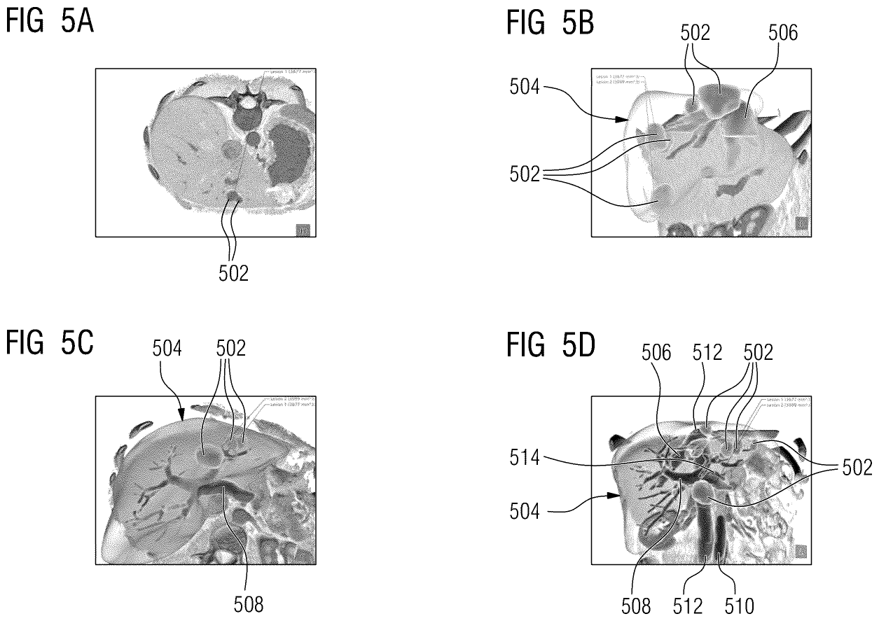

The example in FIGS. 5A to 5D uses an AI-based liver, lesions, and vessels segmentation to synthesize clinically relevant views of patient data for oncological (and/or cancer therapy) support without user intervention. The views may then be assembled into storyboards (and/or the corresponding keyframes may be temporally ordered) for case review, and/or for intervention planning.

The images of FIGS. 5A, 5B, 5C and 5D are illustrative of liver surgery planning (e.g., resection or ablation) based on automatic liver structure detection. The keyframes in the exemplary embodiment of FIGS. 5A, 5B, 5C and 5D are generated automatically. All images of this embodiment combine volume rendering with automated camera, clipping and transfer function, together with mesh rendering of the detected structures.

In FIGS. 5A, 5B, 5C and 5D, at reference sign 502, one or more liver lesions are displayed. In FIGS. 5B, 5C and 5D, at reference sign 504 the liver surface is shown. FIGS. 5B and 5D further show the hepatic veins at reference sign 506. FIGS. 5C and 5D further show the portal veins at reference sign 508. In FIG. 5D, also the aorta 510, inferior vena cava 512 and hepatic arteries 514 are shown.

By the technique, the specification of the timing (e.g., including a frame rate) for each keyframe may be automated (and/or computer-implemented) to constrain the speed of visual changes in the animations (and/or final videos). E.g., the timing specification may be related directly to the camera position between keyframes so that the interpolated intermediary frames and/or the interpolated animation (and/or video) avoid rapid changes in the camera velocity.

One or more image metrics (and/or a perceptual, e.g., difference, metric) may alternatively, or in addition be used to compute an image-space distance (and/or a difference, and/or dissimilarity) between images rendered with consecutive (also: adjacent or neighboring) keyframes.

The timing may be relaxed for keyframes that result in more significant image changes (and/or larger differences in the images). Given an ordering of keyframes, to optimize the timing a direct relaxation of timing for animation parameter (and/or rendering parameter) changes between keyframes that lead to linear spatial changes in the result image may be utilized. The animation (and/or rendering) parameters may in particular include a camera position, orientation, field of view, and/or focal distance.

Alternatively, or in addition, to optimize the timing, separate video frame metric measurements for guiding the timing optimization for parameter changes with non-linear image response may be utilized. (E.g., rendering) parameters may include a windowing, transfer function and/or classification changes, and/or lighting changes. As perceptual metric (and/or image metric) a pHash, structural similarity, BRISQUE, and/or visual entropy may be utilized.

Further alternatively, or in addition, to optimize the timing a hybrid technique (e.g., a hybrid of the direct relaxation and the separate video frame metric measurements) may be utilized with one or more of the following parameters: timing clip plane; crop box, by which a linear movement velocity by optimized. Potentially, the optimization oof the linear movement velocity may result in unbounded change in the perceptual metric (and/or image metric), e.g., clipping through homogeneous tissue vs. clipping near dense vessel structures; and/or volume data fades.

As part of the perceptual metric optimization process, in an embodiment a differentiable renderer may be used to compute the change in differentiable (e.g., rendering) parameters that results in the target image change, e.g., rather than using metric learning approaches or a simpler feedback optimization loop.

Further embodiments and/or more advanced implementations may further optimize the order of the keyframes. A clustering (which may correspond to, or may include, selecting a set of keyframes and/or performing a temporal ordering) of keyframes may be established, e.g., from user-specified tags or constraints related to the image content, so that relevant (e.g., including the same anatomical structure to be rendered) keyframes are clustered together, while the order of the clusters may be modified to minimize video metrics, such as perceived image change (and/or a perceptual difference metric).

The clinical content and/or the visible structures in the existing (and/or selected) keyframes may be determined based on an anatomical segmentation of the 2D rendered images, or the 3D volume data. E.g., a volumetric Monte Carlo path tracing renderer may keep track of the distances between light scattering locations and organ segmentation masks to determine which organs are rendered into each keyframe. The keyframes may be clustered (and/or temporally ordered) automatically (and/or computer-implemented) based on clinical content and the order within each cluster, with the option of an optimization based on one or more perceptual metrics (e.g., image and/or video metrics).

Deep reinforcement learning may be used for keyframe ordering, where an AI agent (also denoted as AI system) learns an optimal policy for selecting a consecutive (and/or) next keyframe given the set of keyframes. Alternatively, or in addition, the AI agent may learn an optimal policy for changing keyframe timing data to optimize quality metrics (e.g., a perceptual, in particular difference, metric) for the animation (and/or final video).

Without loss of generality, an exemplary embodiment of the technique may penalize and/or reward based on a total animation (and/or video) length, and/or camera travel distance; a cumulative and/or maximal perceptual change between final animation (and/or video) frames; and/or a temporal consistency in visible anatomical structures.

In an embodiment, the animation style of a user can be learned, e.g., by the AI agent, based on the above factors as the user (and/or the AI agent) generates many animations. The information on the animation style may be used to suggest keyframe sequence and length for new animations that suit the user's artistic style, area of interest, and/or clinical needs.

In an embodiment, the AI agent (and/or AI system) after learning from clinical and artistic experts may be deployed to new and/or casual users to support effective animation authoring.

In a further embodiment, where the keyframing optimization is combined with automated keyframe synthesis (e.g., based on anatomical segmentation), the AI agent (and/or AI system) may constrain parameters that would result in lower quality animations. As an example, the synthesis may e.g., only use two-axis camera rotations and/or select views closer to an anterior orientation to minimize camera movement in the animation (and/or final videos). Intermediate keyframes may further be synthesized by interpolating the parameters of, e.g., existing, keyframes (and/or snapshots) to allow for higher quality animations.

In any embodiment, the AI agent (and/or AI system) may be implemented by a ML algorithm, and/or a NN. Alternatively, or in addition, metric learning and/or deep reinforcement learning may be examples of Machine Learning (ML) approaches. Further alternatively, or in addition, neural networks (NN) may also be also a type of ML.

In an embodiment, a semi-automatic (and/or computer-aided) animation technique may be used. E.g., the user may manually set up the set (also denoted as sequence) of keyframes including camera view settings (e.g., as one or more rendering parameters). By the technique, other settings (and/or rendering parameters), e.g., exposure, material parameters, rendering optimizations, and/lengths of keyframes based on views, may be optimized.

The technique is independent of any particular choice of rendering algorithm. While the exemplary embodiments target photorealistic rendering of 3D medical images with Monte Carlo path tracing, the technique is broadly applicable to animations produced with other volume rendering, surface rendering, and/or fused volume and surface rendering algorithms.

The technique may be further applied to, e.g., industrial CT and/or scientific visualization.

Simplified rendering algorithms may be used together with the final rendering algorithm, including denoised Monte Carlo path tracing, partial rendering (e.g., with fewer samples per pixel), and/or other optimizations for rapid animation quality evaluations as part of the ML algorithm and/or the optimization process.

Detection of the described techniques in unknown devices and/or systems may be performed by providing specially crafted medical image data (and/or snapshots) to the animation (and/or video) generation. The specially crafted medical image data can modify the rendering (e.g., camera) parameters with a pre-determined range of values, e.g., for translation and/or rotation. An observer can determine if the keyframe timing maintains, e.g., a consistent camera speed in the animation (and/or resulting video). Alternatively, or in addition, different classification functions may be applied to a synthetic medical image (and/or volume) dataset to create various degrees of difference in the images (and/or resulting snapshots), e.g., when measured with a perceptual (in particular, image) metric. An observer can measure the perceptual difference between frames in the (e.g., final) animation to determine if the animation (and/or final video) results in a more consistent change in the perceptual (and/or image) metric between frames than a trivial keyframe timing.

Other aspects of the technique, such as the automated keyframe ordering, may be reviewed in a similar manner.

Wherever not already described explicitly, individual embodiments, or their individual aspects and features, described in relation to the drawings can be combined or exchanged with one another without limiting or widening the scope of the described invention, whenever such a combination or exchange is meaningful and in the sense of this invention. Advantages which are described with respect to a particular embodiment of present invention or with respect to a particular figure are, wherever applicable, also advantages of other embodiments of the present invention.

1. A computer-implemented method for rendering animations of medical images, the method comprising:
receiving at least one input, wherein each of the at least one input comprises a medical image dataset;
selecting a set of keyframes associated with the received at least one input, wherein a keyframe comprises predetermined values of a set of rendering parameters;
generating intermediary frames in a temporal sequence between two consecutive ones of the keyframes, wherein the consecutive keyframes are consecutive according to a temporal ordering of the keyframes within the selected set of keyframes, wherein generating the intermediary frames is based on optimizing a perceptual metric associated with the selected set of keyframes and the generated intermediary frames, and wherein optimizing the perceptual metric comprises optimizing the perceptual metric as a function of values of the set of rendering parameters associated with each of the intermediary frames; and
rendering an animation using the generated intermediary frames and the selected set of keyframes.

2. The method according to claim 1, wherein the perceptual metric is selected from the group consisting of:
perceptual hash, pHash;
structural similarity;
visual entropy; and
blend reference image spatial quality evaluator, BRISQUE.

3. The method according to claim 1, wherein the at least one input comprises a two-dimensional medical image dataset, a three-dimensional medical image dataset, and/or a four-dimensional medical image dataset.

4. The method according to claim 1, wherein the medical image dataset comprised in at least one input is received from a medical scanner.

5. The method according to claim 1, wherein the medical image dataset comprises at least two different medical image datasets obtained from at least two different medical scanners.

6. The method according to claim 1, wherein the set of rendering parameters comprises at least one rendering parameter selected from the group consisting of:
camera parameter;
clipping parameter;
classification parameter; and
lighting preset parameter.

7. The method according to claim 1, further comprising:
temporally ordering the keyframes within the selected set of keyframes.

8. The method according to claim 7, wherein temporally ordering comprises temporally ordering is based on optimizing a perceptual metric.

9. The method according to claim 8, wherein an initial temporal ordering is modified when a value of the perceptual metric for the temporal ordering exceeds a predetermined threshold value indicative of a perceptual dissimilarity.

10. The method according to claim 1, wherein a length of a time interval between consecutive intermediary frames and/or an intermediary frame rate is constant between two consecutive keyframes.

11. The method according to claim 1, wherein generating the intermediary frames in the temporal sequence further comprises extending a length of a time interval between at least one pair of consecutive keyframes within the selected set of keyframes and expanding the selected set of keyframes by promoting one or more intermediary frames to keyframes, which are added to the selected set of keyframes to form an expanded set of keyframes, wherein the to be promoted one or more intermediary frames are associated with the at least one pair of consecutive keyframes for which the length of the time interval has been extended, and wherein generating the intermediary frames in the temporal sequence is repeated for the expanded set of keyframes.

12. The method according to claim 11, wherein the promoting of one or more intermediary frames to keyframes is performed when the perceptual metric between consecutive intermediary frames comprising the to-be-promoted one or more intermediary frames exceeds a predetermined threshold indicative of a perceptual dissimilarity.

13. The method according to claim 1, wherein the input comprises one or more animations, and wherein the one or more animations are comprised in the rendered animation.

14. The method according to claim 1, wherein rendering comprises differentiable rendering.

15. The method according to claim 1, wherein the method is performed by a neural network and/or using artificial intelligence.

16. A system for rendering animations of medical images, the system comprising:
a receiver configured for receiving at least one input, wherein each of the at least one input comprises a medical image dataset;
a computer configured to:
select a set of keyframes associated with the received at least one input, wherein a keyframe comprises predetermined values of a set of rendering parameters, andgenerate intermediary frames in a temporal sequence between two consecutive keyframes, wherein the consecutive keyframes are consecutive according to a temporal ordering of the keyframes within the selected set of keyframes, wherein the intermediary frames are generated based on optimization of a perceptual metric associated with the selected set of keyframes and the generated intermediary frames, and wherein the optimization of the perceptual metric comprises optimization of the perceptual metric as a function of values of the set of rendering parameters associated with each of the intermediary frames; and
a renderer configured to render an animation using the generated intermediary frames and the selected set of keyframes.

17. The system according to claim 16 wherein the set of rendering parameters comprises at least one rendering parameter selected from the group consisting of:
camera parameter;
clipping parameter;
classification parameter; and
lighting preset parameter;
wherein the computer is configured to temporally order the keyframes within the selected set of keyframes based on optimization of the perceptual metric.

18. The system according to claim 17, wherein a length of a time interval between consecutive intermediary frames and/or an intermediary frame rate is constant between two consecutive keyframes;
wherein the intermediary frames are generated in the temporal sequence by extension of a length of a time interval between at least one pair of consecutive keyframes within the selected set of keyframes and expansion of the selected set of keyframes by promotion of one or more intermediary frames to keyframes, which are added to the selected set of keyframes to form an expanded set of keyframes, wherein the to be promoted one or more intermediary frames are associated with the at least one pair of consecutive keyframes for which the length of the time interval has been extended, and wherein generation of the intermediary frames in the temporal sequence is repeated for the expanded set of keyframes.

19. A non-transitory computer readable storage medium comprising program elements which induce a computer, when executed, to:
receive at least one input, wherein each of the at least one input comprises a medical image dataset;
select a set of keyframes associated with the received at least one input, wherein a keyframe comprises predetermined values of a set of rendering parameters;
generate intermediary frames in a temporal sequence between two consecutive ones of the keyframes, wherein the consecutive keyframes are consecutive according to a temporal ordering of the keyframes within the selected set of keyframes, wherein generating the intermediary frames is based on optimizing a perceptual metric associated with the selected set of keyframes and the generated intermediary frames, and wherein optimizing the perceptual metric comprises optimizing the perceptual metric as a function of values of the set of rendering parameters associated with each of the intermediary frames; and
render an animation using the generated intermediary frames and the selected set of keyframes.
